(19) United States
(12) Patent Application Publication
(10) Pub. No.: US 2026/0008336 A1
(43) Pub. Date: Jan. 8, 2026

(54) SHIFTING APPARATUS

(71) Applicant: KABUSHIKI KAISHA TOKAI-RIKA-DENKI-SEISAKUSHO, Aichi (JP)

(72) Inventors: Makoto YAMAMOTO, Niwa-gun, Aichi (JP); Yutaka INAMURA, Niwa-gun, Aichi (JP); Takuya WATANABE, Niwa-gun, Aichi (JP); Noriyasu SAKAI, Niwa-gun, Aichi (JP); Kota NISIDA, Niwa-gun, Aichi (JP)

(73) Assignee: KABUSHIKI KAISHA TOKAI-RIKA-DENKI-SEISAKUSHO, Aichi (JP)

(21) Appl. No.: 18/881,685

(22) PCT Filed: Jul. 10, 2023
(86) PCT No.: PCT/JP2023/025503

§ 371 Date: Jan. 6, 2025

(30) Foreign Application Priority Data
Jul. 13, 2022 (JP) 2022-112619

(51) Int. Cl. B60K 20/08; B60K 35/10; B60K 35/21; B60K 35/26; F16H 59/02

(52) U.S. Cl. CPC B60K 20/08; B60K 35/10; B60K 35/21; B60K 35/265; F16H 59/02

(57) ABSTRACT

A shifting apparatus includes shift switches, electrostatic sensors and a light output unit. The shift switches provide operation instructions in accordance with contacts by an operating hand. The electrostatic sensors are an approach sensing unit that senses an approach of the operating hand toward a shift switch. The light output unit is a notification unit that, based on sensing information from the electrostatic sensors, makes a notification that the operating hand is approaching that shift switch.

### TECHNICAL FIELD

The present disclosure relates to a shifting apparatus.

### BACKGROUND ART

A shift-by-wire shifting apparatus is known (for example, see the Description of U.S. Patent Application Publication No. 2016/0363214) with which a shift range position may be changed by a contact from an operating hand of a driver.

The Description of U.S. Patent Application Publication No. 2016/0363214, discloses a button-type electric gear shifting apparatus in which a gear shift stage may be changed by a driver operating one or other of plural buttons to select a desired gear shift stage.

In this kind of shifting apparatus, inhibiting misoperation is preferable.

### SUMMARY OF INVENTION

### Technical Problem

The present disclosure relates to a shifting apparatus that may inhibit misoperation.

### Solution to Problem

A shifting apparatus according to a first aspect of the present disclosure includes: a shift switch that provides an operation instruction in accordance with contact of an operating hand; an approach sensing unit that senses an approach of the operating hand toward the shift switch; and a notification unit that, based on sensing information from the approach sensing unit, makes a notification that the operating hand has approached the shift switch.

In a shifting apparatus according to a second aspect of the present disclosure, in the shifting apparatus according to the first aspect of the present disclosure, at least two of the shift switch are provided in a row, and the notification unit makes a notification for a shift switch among the at least two shift switches that the operating hand has approached.

In a shifting apparatus according to a third aspect of the present disclosure, in the shifting apparatus according to the second aspect of the present disclosure, the at least two shift switches are disposed in a row at a flat surface.

In a shifting apparatus according to a fourth aspect of the present disclosure, in the shifting apparatus according to any one of the first to third aspects of the present disclosure, based on the sensing information from the approach sensing unit, the notification unit makes notifications in stages that the operating hand is approaching the shift switch.

In a shifting apparatus according to a fifth aspect of the present disclosure, in the shifting apparatus according to any one of the first to fourth aspects of the present disclosure, the notification unit is a light output unit that outputs light.

In a shifting apparatus according to a sixth aspect of the present disclosure, in the shifting apparatus according to any one of the first to fifth aspects of the present disclosure, the notification unit is a sound output unit that outputs sound.

### Advantageous Effects of Invention

In the shifting apparatus according to the first aspect of the present disclosure, the notification unit is provided that, based on sensing information from the approach sensing unit, makes a notification when an operating hand is approaching the shift switch. Therefore, when a driver acts to press the shift switch and causes the operating hand to approach the shift switch, a notification is made that the operating hand is approaching the shift switch. Consequently, the driver may identify the shift switch before pressing the shift switch. As a result, a misoperation in which a shift switch is mistakenly pressed may be inhibited.

In the shifting apparatus according to the second aspect of the present disclosure, the notification unit makes a notification of which shift switch of the two or more shift switches is being approached. Thus, when a driver acts to press a shift switch and causes the operating hand to approach an object shift switch, a notification is made that the operating hand is approaching the object shift switch. Consequently, the driver may identify the object shift switch before pressing the shift switch. As a result, a misoperation in which an object shift switch is mistakenly pressed may be inhibited.

In the shifting apparatus according to the third aspect of the present disclosure, even though the two or more shift switches are disposed in a row in the flat surface, the driver may identify an object shift switch before pressing a shift switch. As a result, a misoperation in which an object shift switch is mistakenly pressed may be inhibited.

In the shifting apparatus according to the fourth aspect of the present disclosure, based on sensing information from the approach sensing unit, the notification unit makes notifications in stages that the operating hand is approaching the shift switch. Therefore, when a driver acts to press the shift switch and causes the operating hand to approach the shift switch, notification that the operating hand is approaching the shift switch is given in stages. Consequently, the driver may identify the shift switch to be pressed in stages before pressing the shift switch. As a result, a misoperation in which a shift switch is mistakenly pressed may be inhibited.

In the shifting apparatus according to the fifth aspect of the present disclosure, the notification unit is the light output unit. Thus, when a driver acts to press a shift switch and causes the operating hand to approach the shift switch, a notification that the operating hand is approaching the shift switch is given by light. Consequently, the driver may visually identify the shift switch before pressing the shift switch. As a result, a misoperation in which a shift switch is mistakenly pressed may be inhibited.

In the shifting apparatus according to the sixth aspect of the present disclosure, the notification unit is the sound output unit. Thus, when a driver acts to press a shift switch and causes the operating hand to approach the shift switch, a notification that the operating hand is approaching the shift switch is given by sound. Consequently, the driver may aurally identify the shift switch before pressing the shift switch. As a result, a misoperation in which a shift switch is mistakenly pressed may be inhibited.

### BRIEF DESCRIPTION OF DRAWINGS

FIG. 1 is a schematic view, looking to the front of a vehicle from inside a vehicle cabin, showing an instrument panel at which a shifting apparatus according to a present exemplary embodiment is provided.

FIG. 2 is a perspective view showing a shifting apparatus according to the present exemplary embodiment.

FIG. 3 is a sectional diagram showing the shifting apparatus according to the present exemplary embodiment, depicting section A-A in FIG. 2.

FIG. 4 is a block diagram showing functional structures of the shifting apparatus according to the present exemplary embodiment.

FIG. 5 is a flowchart showing flows of processing of the shifting apparatus according to the present exemplary embodiment.

FIG. 6 is a perspective view showing a state in which an operating hand has approached a parking switch of the shifting apparatus according to the present exemplary embodiment.

FIG. 7A is a perspective view showing a state in which an operating hand has approached a parking switch of a shifting apparatus according to an alternative embodiment.

FIG. 7B is a perspective view showing a state in which an operating hand has approached a parking switch of a shifting apparatus according to another alternative embodiment.

### DESCRIPTION OF EMBODIMENTS

Below, a shifting apparatus according to a present exemplary embodiment is described with reference to the drawings. In the present exemplary embodiment, a shifting apparatus 20 is described as an example of a shift-by-wire shifting apparatus for a vehicle at which a shifting operation is carried out by selection of a shift switch.

In the drawings, the arrow UP indicates upward in the vehicle, the arrow RH indicates rightward in the vehicle, and the arrow D indicates a longitudinal direction D of the shifting apparatus 20. Where descriptions are given simply using “one end side” and “other end side”, unless particularly specified, these are sides in the longitudinal direction D of the shifting apparatus 20.

### Structures of Shifting Apparatus

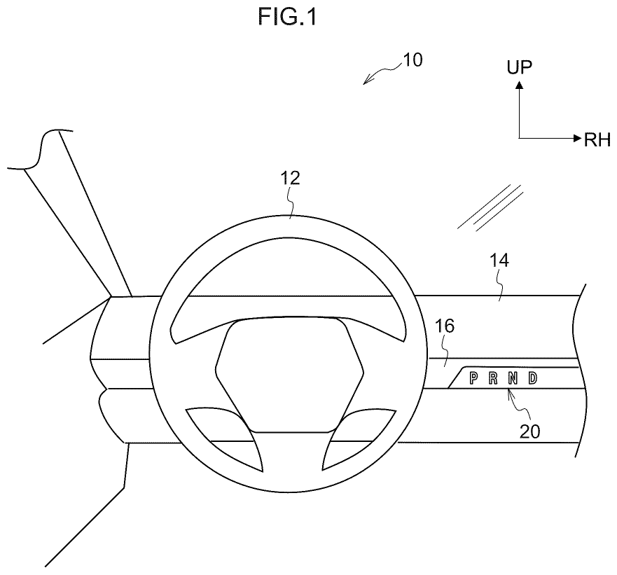

As shown in FIG. 1, the shifting apparatus 20 according to the present exemplary embodiment is disposed at an instrument panel 14, which is provided at the front side of a vehicle cabin interior of a vehicle 10. The shifting apparatus 20 is provided along a garnish 16 that extends in the vehicle width direction at the vehicle right side of a steering wheel 12.

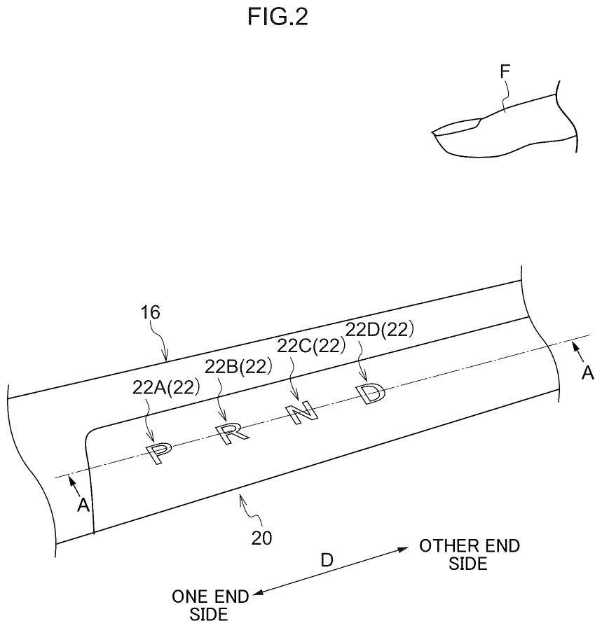

As shown in FIG. 2, as shift switches 22 of the shifting apparatus 20, a parking switch 22A, a reverse switch 22B, a neutral switch 22C and a drive switch 22D are disposed in a row from one end side to the other end side in the longitudinal direction D. A driver sits on a driver seat and, by an operating hand (finger) F of the driver touching the shift switches 22, switches between shift range positions, which are a parking position P, a reverse position R, a neutral position N and a drive position D.

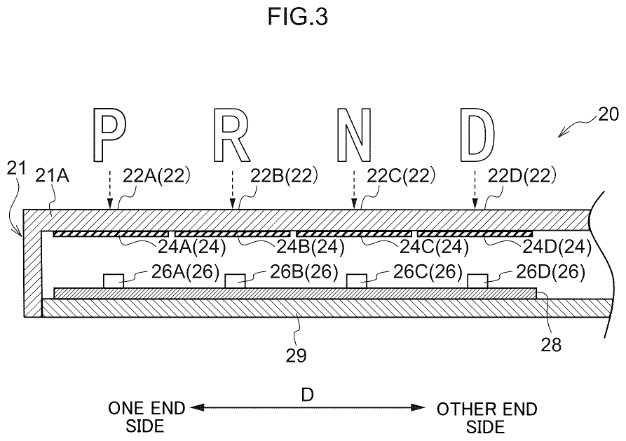

As shown in FIG. 3, the shifting apparatus 20 is provided with an upper housing 21, electrostatic sensors 24 that serve as a sensing approach unit, a printed circuit board 28, a light output unit 26 that serves as a notification unit, and a case 29.

### Upper Housing 21

The upper housing 21 is formed in a rectangular box shape of which one side is open. A character region P forming the letter “P”, a character region R forming the letter “R”, a character region N forming the letter “N” and a character region D forming the letter “D” are formed at the upper housing 21, at a top plate 21A structuring a design surface.

The character region P structures the parking switch 22A, the character region R structures the reverse switch R, the character region C structures the neutral switch 22C, and the character region D structures the drive switch 22D. The parking switch 22A, the reverse switch R, the neutral switch 22C and the drive switch 22D are disposed in a flat surface in a row in the longitudinal direction D.

The character region P, character region R, character region N and character region D of the upper housing 21 are formed to be transparent. The upper housing 21 may, for example, be formed of a transparent resin material, and a non-transparent coating may be applied to the upper housing 21 except at the character region P, character region R, character region N and character region D. Alternatively, the upper housing 21 may be formed of a transparent resin member to which a non-transparent film is applied with the character region P, character region R, character region N and character region D cut out.

### Case 29 and Printed Circuit Board 28

The case 29 is disposed so as to close off the opening of the upper housing 21. The printed circuit board 28 is disposed on an upper face of the case 29.

### Electrostatic Sensors 24

The electrostatic sensors 24 are, for example, formed to be transparent and are attached to a back face of the top plate 21A of the upper housing 21. The electrostatic sensors 24 are structured by a first electrostatic sensor 24A disposed at a position corresponding with the character region P, a second electrostatic sensor 24B disposed at a position corresponding with the character region R, a third electrostatic sensor 24C disposed at a position corresponding with the character region N, and a fourth electrostatic sensor 24D disposed at a position corresponding with the character region D.

The first electrostatic sensor 24A measures a change in electrostatic capacitance caused by an approach of the operating hand F toward the character region P. That is, the first electrostatic sensor 24A senses the approach of the operating hand F toward the parking switch 22A. The second electrostatic sensor 24B measures a change in electrostatic capacitance caused by an approach of the operating hand F toward the character region R. That is, the second electrostatic sensor 24B senses the approach of the operating hand F toward the reverse switch 22B. The third electrostatic sensor 24C measures a change in electrostatic capacitance caused by an approach of the operating hand F toward the character region N. That is, the third electrostatic sensor 24C senses the approach of the operating hand F toward the neutral switch 22C. The fourth electrostatic sensor 24D measures a change in electrostatic capacitance caused by an approach of the operating hand F toward the character region D. That is, the fourth electrostatic sensor 24D senses the approach of the operating hand F toward the drive switch 22D.

### Light Output Unit 26

The light output unit 26 is disposed on an upper face of the printed circuit board 28. The light output unit 26 may be light-emitting diodes (LEDs) that output light. The light output unit 26 is structured by a first light output portion 26A disposed at a position corresponding with the character region P, a second light output portion 26B disposed at a position corresponding with the character region R, a third light output portion 26C disposed at a position corresponding with the character region N, and a fourth light output portion 26D disposed at a position corresponding with the character region D.

The character region P lights up when the first light output portion 26A emits light, the character region R lights up when the second light output portion 26B emits light, the character region N lights up when the third light output portion 26C emits light, and the character region D lights up when the fourth light output portion 26D emits light.

### Functional Structures of the Shifting Apparatus

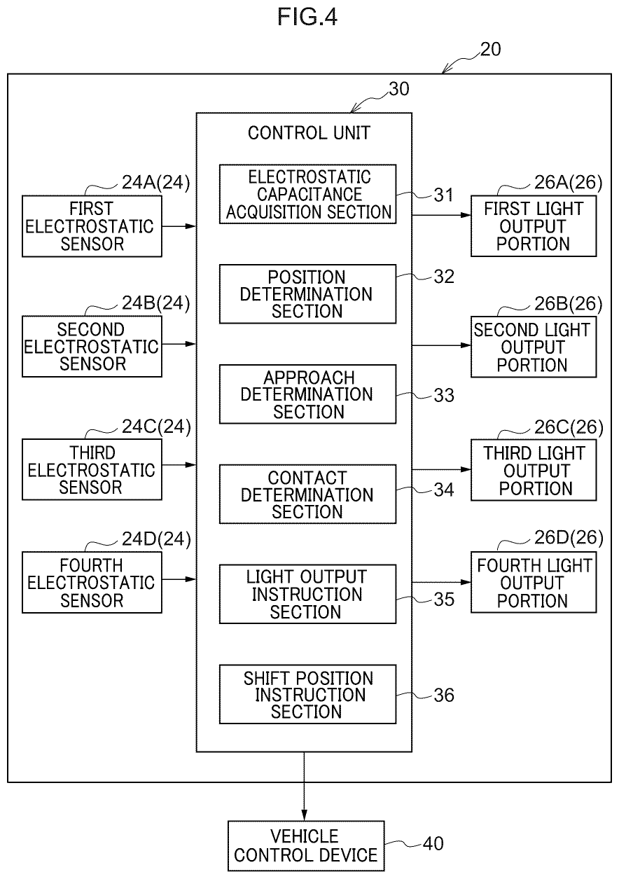

As illustrated in FIG. 4, functionally, the shifting apparatus 20 inputs sensing information from the electrostatic sensors 24 to a control unit 30 and outputs information processed by the control unit 30 to the light output unit 26 and a vehicle control device 40.

The first electrostatic sensor 24A measures a change in electrostatic capacitance caused by an approach of the operating hand F toward the character region P, and measurement information from the first electrostatic sensor 24A is inputted to the control unit 30. The second electrostatic sensor 24B measures a change in electrostatic capacitance caused by an approach of the operating hand F toward the character region R, and measurement information from the second electrostatic sensor 24B is inputted to the control unit 30. The third electrostatic sensor 24C measures a change in electrostatic capacitance caused by an approach of the operating hand F toward the character region N, and measurement information from the third electrostatic sensor 24C is inputted to the control unit 30. The fourth electrostatic sensor 24D measures a change in electrostatic capacitance caused by an approach of the operating hand F toward the character region D, and measurement information from the fourth electrostatic sensor 24D is inputted to the control unit 30.

The control unit 30 is provided with an electrostatic capacitance acquisition section 31, a position determination section 32, an approach determination section 33, a contact determination section 34, a light output instruction section 35 and a shift position instruction section 36. The electrostatic capacitance acquisition section 31 acquires electrostatic capacitances sensed by the electrostatic sensors 24.

The position determination section 32 determines a shift range position in accordance with the electrostatic sensors 24 sensing electrostatic capacitances. More specifically, when the first electrostatic sensor 24A senses a change in electrostatic capacitance, the position determination section 32 determines that the shift range position is the parking position P. When the second electrostatic sensor 24B senses a change in electrostatic capacitance, the position determination section 32 determines that the shift range position is the reverse position R. When the third electrostatic sensor 24C senses a change in electrostatic capacitance, the position determination section 32 determines that the shift range position is the neutral position N. When the fourth electrostatic sensor 24D senses a change in electrostatic capacitance, the position determination section 32 determines that the shift range position is the drive position D.

Based on electrostatic capacitances acquired by the electrostatic capacitance acquisition section 31, the approach determination section 33 determines whether or not the operating hand F has approached into a predetermined range from the shift switches 22 (for example, 2 to 3 cm). More specifically, the approach determination section 33 determines whether or not an electrostatic capacitance acquired by the electrostatic capacitance acquisition section 31 is greater than a predetermined threshold value A.

Based on electrostatic capacitances acquired by the electrostatic capacitance acquisition section 31, the contact determination section 34 determines whether or not the operating hand F is in contact with the shift switches 22. More specifically, the contact determination section 34 determines whether or not an electrostatic capacitance acquired by the electrostatic capacitance acquisition section 31 is greater than a predetermined threshold value B.

Based on a determination result from the position determination section 32 and a determination result from the approach determination section 33, the light output instruction section 35 lights up one of the first light output portion 26A to fourth light output portion 26D.

More specifically, when the position determination section 32 determines that a shift range position is the parking position P and the approach determination section 33 determines that the operating hand F has approached into the predetermined range (for example, 2 to 3 cm) from the shift switches 22, the light output instruction section 35 provides an output instruction to the first light output portion 26A. When the position determination section 32 determines that the shift range position is the reverse position R and the approach determination section 33 determines that the operating hand F has approached into the predetermined range (for example, 2 to 3 cm) from the shift switches 22, the light output instruction section 35 provides an output instruction to the second light output portion 26B. When the position determination section 32 determines that the shift range position is the neutral position N and the approach determination section 33 determines that the operating hand F has approached into the predetermined range (for example, 2 to 3 cm) from the shift switches 22, the light output instruction section 35 provides an output instruction to the third light output portion 26C. When the position determination section 32 determines that the shift range position is the drive position D and the approach determination section 33 determines that the operating hand F has approached into the predetermined range (for example, 2 to 3 cm) from the shift switches 22, the light output instruction section 35 provides an output instruction to the fourth light output portion 26D.

Based on a determination result from the position determination section 32 and a determination result from the contact determination section 34, the shift position instruction section 36 provides a predetermined instruction to the vehicle control device 40.

More specifically, when the position determination section 32 determines that the shift range position is the parking position P and the contact determination section 34 determines that the operating hand F has made contact with that shift switch 22, the shift position instruction section 36 provides a parking position P instruction to the vehicle control device 40. When the position determination section 32 determines that the shift range position is the reverse position R and the contact determination section 34 determines that the operating hand F has made contact with that shift switch 22, the shift position instruction section 36 provides a reverse position R instruction to the vehicle control device 40. When the position determination section 32 determines that the shift range position is the neutral position N and the contact determination section 34 determines that the operating hand F has made contact with that shift switch 22, the shift position instruction section 36 provides a neutral position N instruction to the vehicle control device 40. When the position determination section 32 determines that the shift range position is the drive position D and the contact determination section 34 determines that the operating hand F has made contact with that shift switch 22, the shift position instruction section 36 provides a drive position D instruction to the vehicle control device 40.

### Flow of Notification Processing by the Shifting Apparatus

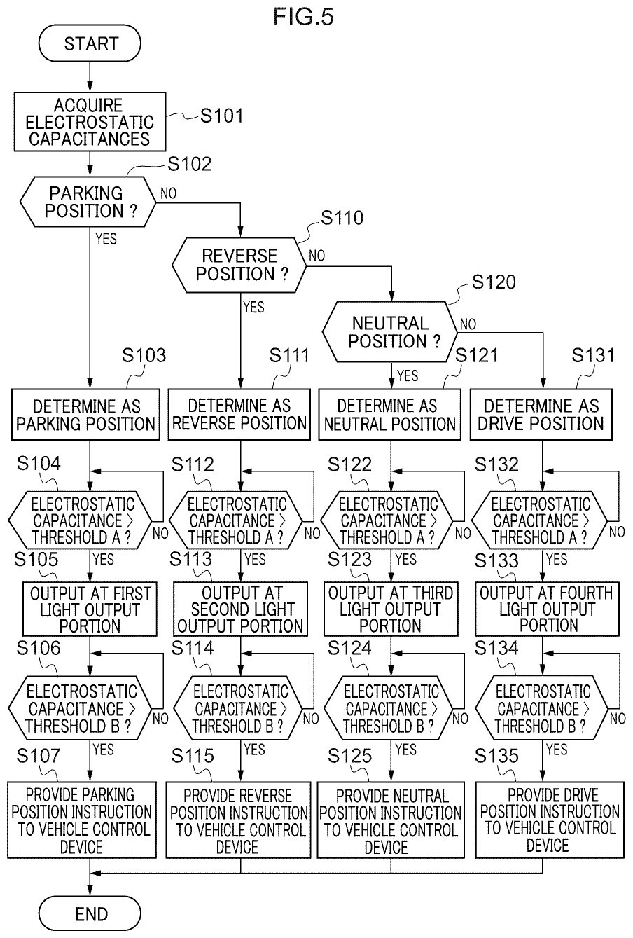

When the notification processing as illustrated in FIG. 5 is started, the electrostatic capacitance acquisition section 31 acquires electrostatic capacitances sensed by the electrostatic sensors 24 (step S101).

Then the position determination section 32 makes a determination as to whether the shift range position is the parking position P (step S102). When a determination is made that the shift range position is the parking position P (YES in step S102), the position determination section 32 determines that the shift range position is the parking position P (step S103).

Then the approach determination section 33 makes a determination as to whether an electrostatic capacitance acquired by the electrostatic capacitance acquisition section 31 is greater than the predetermined threshold value A (step S104). When the approach determination section 33 determines that the electrostatic capacitance is greater than the predetermined threshold value A (YES in step S104), the control unit 30 proceeds to step S105. Alternatively, when the approach determination section 33 determines that the electrostatic capacitance is smaller than the predetermined threshold value A (NO in step S104), the control unit 30 returns to step S104.

When the control unit 30 proceeds to step S105, the light output instruction section 35 provides an output instruction to the first light output portion 26A. As a result, the first light output portion 26A clearly shows the parking switch 22A, making a notification.

Then the contact determination section 34 makes a determination as to whether an electrostatic capacitance acquired by the electrostatic capacitance acquisition section 31 is greater than the predetermined threshold value B (step S106). When the contact determination section 34 determines that the electrostatic capacitance is greater than the predetermined threshold value B (YES in step S106), the control unit 30 proceeds to step S107. Alternatively, when the contact determination section 34 determines that the electrostatic capacitance is smaller than the predetermined threshold value B (NO in step S106), the control unit 30 returns to step S106.

When the control unit 30 proceeds to step S107, the shift position instruction section 36 provides a parking position P instruction to the vehicle control device 40 and the notification processing ends.

Alternatively, when a determination is made that the shift range position is not the parking position P (NO in step S102), the position determination section 32 makes a determination as to whether the shift range position is the reverse position R (step S110). When a determination is made that the shift range position is the reverse position R (YES in step S110), the position determination section 32 determines that the shift range position is the reverse position R (step S111).

Then the approach determination section 33 makes a determination as to whether an electrostatic capacitance acquired by the electrostatic capacitance acquisition section 31 is greater than the predetermined threshold value A (step S112). When the approach determination section 33 determines that the electrostatic capacitance is greater than the predetermined threshold value A (YES in step S112), the control unit 30 proceeds to step S113. Alternatively, when the approach determination section 33 determines that the electrostatic capacitance is smaller than the predetermined threshold value A (NO in step S112), the control unit 30 returns to step S112.

When the control unit 30 proceeds to step S113, the light output instruction section 35 provides an output instruction to the second light output portion 26B. As a result, the second light output portion 26B clearly shows the reverse switch 22B, making a notification.

Then the contact determination section 34 makes a determination as to whether an electrostatic capacitance acquired by the electrostatic capacitance acquisition section 31 is greater than the predetermined threshold value B (step S114). When the contact determination section 34 determines that the electrostatic capacitance is greater than the predetermined threshold value B (YES in step S114), the control unit 30 proceeds to step S115. Alternatively, when the contact determination section 34 determines that the electrostatic capacitance is smaller than the predetermined threshold value B (NO in step S114), the control unit 30 returns to step S114.

When the control unit 30 proceeds to step S115, the shift position instruction section 36 provides a reverse position R instruction to the vehicle control device 40 and the notification processing ends.

Alternatively, when a determination is made that the shift range position is not the reverse position R (NO in step S110), the position determination section 32 makes a determination as to whether the shift range position is the neutral position N (step S120). When a determination is made that the shift range position is the neutral position N (YES in step S120), the position determination section 32 determines that the shift range position is the neutral position N (step S121).

Then the approach determination section 33 makes a determination as to whether an electrostatic capacitance acquired by the electrostatic capacitance acquisition section 31 is greater than the predetermined threshold value A (step S122). When the approach determination section 33 determines that the electrostatic capacitance is greater than the predetermined threshold value A (YES in step S122), the control unit 30 proceeds to step S123. Alternatively, when the approach determination section 33 determines that the electrostatic capacitance is smaller than the predetermined threshold value A (NO in step S122), the control unit 30 returns to step S122.

When the control unit 30 proceeds to step S123, the light output instruction section 35 provides an output instruction to the third light output portion 26C. As a result, the third light output portion 26C clearly shows the neutral switch 22C, making a notification.

Then the contact determination section 34 makes a determination as to whether an electrostatic capacitance acquired by the electrostatic capacitance acquisition section 31 is greater than the predetermined threshold value B (step S124). When the contact determination section 34 determines that the electrostatic capacitance is greater than the predetermined threshold value B (YES in step S124), the control unit 30 proceeds to step S125. Alternatively, when the contact determination section 34 determines that the electrostatic capacitance is smaller than the predetermined threshold value B (NO in step S124), the control unit 30 returns to step S124.

When the control unit 30 proceeds to step S125, the shift position instruction section 36 provides a neutral position N instruction to the vehicle control device 40 and the notification processing ends.

Alternatively, when a determination is made that the shift range position is not the neutral position N (NO in step S120), the position determination section 32 determines that the shift range position is the drive position D (step S131).

Then the approach determination section 33 makes a determination as to whether an electrostatic capacitance acquired by the electrostatic capacitance acquisition section 31 is greater than the predetermined threshold value A (step S132). When the approach determination section 33 determines that the electrostatic capacitance is greater than the predetermined threshold value A (YES in step S132), the control unit 30 proceeds to step S133. Alternatively, when the approach determination section 33 determines that the electrostatic capacitance is smaller than the predetermined threshold value A (NO in step S132), the control unit 30 returns to step S132.

When the control unit 30 proceeds to step S133, the light output instruction section 35 provides an output instruction to the fourth light output portion 26D. As a result, the fourth light output portion 26D clearly shows the drive switch 22D, making a notification.

Then the contact determination section 34 makes a determination as to whether an electrostatic capacitance acquired by the electrostatic capacitance acquisition section 31 is greater than the predetermined threshold value B (step S134). When the contact determination section 34 determines that the electrostatic capacitance is greater than the predetermined threshold value B (YES in step S134), the control unit 30 proceeds to step S135. Alternatively, when the contact determination section 34 determines that the electrostatic capacitance is smaller than the predetermined threshold value B (NO in step S134), the control unit 30 returns to step S134.

When the control unit 30 proceeds to step S135, the shift position instruction section 36 provides a drive position D instruction to the vehicle control device 40 and the notification processing ends.

### Operation of the Present Exemplary Embodiment

The shifting apparatus 20 according to the present exemplary embodiment (see FIG. 3) includes the shift switches 22 that provide an operation instruction in accordance with contact by an operating hand F, the electrostatic sensors 24 that serve as an approach sensing unit sensing an approach of the operating hand F toward the shift switches 22, and the light output unit 26 that serves as a notification unit making a notification when the operating hand F approaches the shift switches 22 based on sensing information from the electrostatic sensors 24.

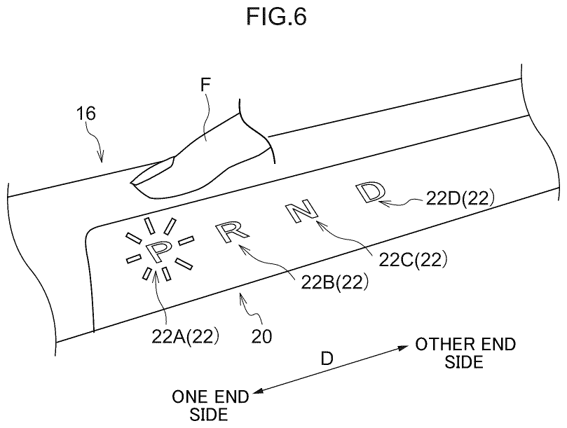

The light output unit 26 is provided that, based on sensing information from the electrostatic sensors 24, makes a notification that the operating hand F is approaching the shift switches 22. Therefore, for example, when a driver acts to press the parking switch 22A and causes the operating hand F to approach the parking switch 22A as illustrated in FIG. 6, a notification is made that the operating hand F is approaching the parking switch 22A. Consequently, the driver may identify one of the shift switches 22 before pressing the shift switch 22. As a result, a misoperation in which one of the shift switches 22 is mistakenly pressed may be inhibited.

In the shifting apparatus 20 according to the present exemplary embodiment, the four shift switches 22 are provided in a row, and the light output unit 26 clearly shows, of the four shift switches 22, the shift switch 22 that the operating hand F is approaching, thus making a notification (see FIG. 3).

Because the light output unit 26 clearly shows, of the four shift switches 22, the shift switch 22 that the operating hand F is approaching to make the notification, when the driver acts to press the shift switch 22 and causes the operating hand F to approach an object among the shift switches 22, a notification is made that the operating hand F is approaching the object shift switch 22.

For example, when the operating hand F acts to press a position between two of the shift switches 22 disposed in the row, the driver may identify which of the shift switches 22 is selected beforehand. As a result, a misoperation in which the driver presses an object among the shift switches 22 mistakenly may be inhibited.

In the shifting apparatus 20 according to the present exemplary embodiment, at least two of the shift switches 22 are disposed in a row at a flat surface (see FIG. 3).

When two or more of the shift switches 22 are disposed in a row in the flat surface, boundaries between the shift switches 22 are hard to recognize. Therefore, the driver may mistakenly press an object among the shift switches 22.

In the present exemplary embodiment, even though the four shift switches 22 are disposed in a row in the flat surface, the driver may identify the object shift switch 22 before pressing the shift switch 22. As a result, a misoperation in which the object shift switch 22 is mistakenly pressed may be inhibited.

In addition, because there is no need to provide components that form boundaries between the shift switches 22, the shifting apparatus 20 may be reduced in size.

While the shifting apparatus of the present disclosure is described in accordance with the exemplary embodiment above, specific structures are not limited by this exemplary embodiment. Design changes and the like that do not depart from the gist of the invention according to the scope of the attached claims may be embodied.

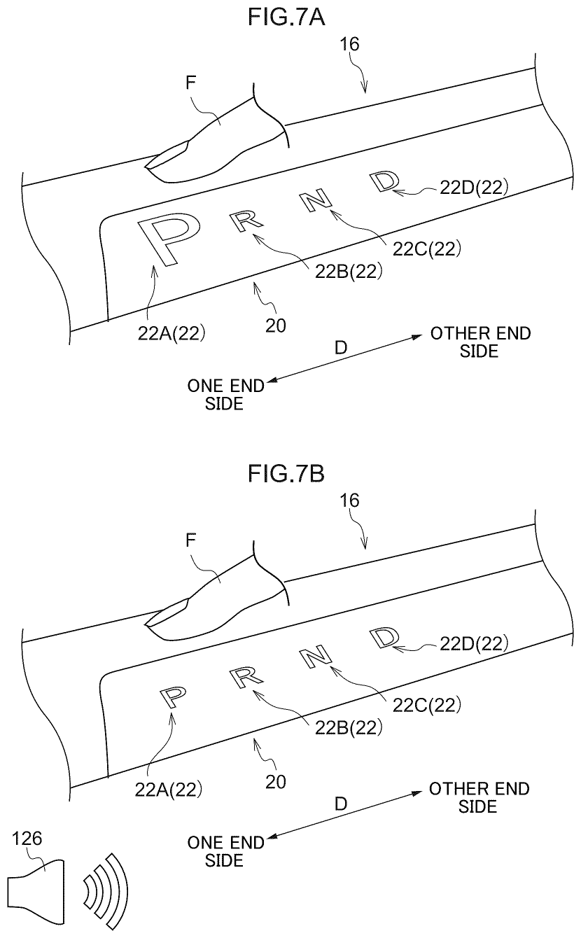

As illustrated in FIG. 7A, the shifting apparatus 20 may be formed with a touch panel and, for example, when the operating hand F approaches the parking switch 22A, the character region P may be shown enlarged.

Further, when the operating hand F approaches, for example, the parking switch 22A, the character region P may be lit up in an altered color, or lighting of the character region P may be flashed.

When, for example, the operating hand F approaches the parking switch 22A, the character region P may be extinguished and the other character regions (the character region R, the character region N and the character region D) may be lit up.

When, for example, the operating hand F approaches the parking switch 22A, the character region P, the character region R, the character region N and the character region D may be lit up.

When all of the shift switches 22 are lit up and the operating hand F approaches, for example, the parking switch 22A, illumination of the character region P may be maintained and the other character regions (the character region R, the character region N and the character region D) may be extinguished.

From a blackout state in which all of the shift switches 22 are unlit, when the operating hand F approaches, for example, the parking switch 22A, the character P may be lit up.

When, for example, the operating hand F approaches the parking switch 22A, both the character region P may be lit up and a display of a display unit disposed at another location (for example, an instrument display) may be similarly lit up.

The exemplary embodiment described above illustrates an example in which the notification unit is the light output unit 26. However, as illustrated in FIG. 7B, the notification unit may be a sound output unit 126 that outputs sound. When, for example, the operating hand F approaches the parking switch 22A of this structure, the sound output unit 126 may output a voice message, “P range”.

The exemplary embodiment described above illustrates an example in which the shift switches 22 light up when the operating hand F approaches the shift switches 22. However, when the operating hand F approaches the shift switches 22, the shift switches 22 may light up in stages so as to gradually increase in brightness.

The exemplary embodiment described above illustrates an example in which the shift switches 22 are disposed in a row in the vehicle width direction. However, the shift switches are not limited to this mode but may be disposed in a row in the vehicle vertical direction, or may be disposed in an “L” shape, a cross shape or a ring shape.

The exemplary embodiment described above illustrates an example in which the approach sensing unit is the electrostatic sensors 24. However, it is sufficient that the approach sensing unit is capable of sensing approaches of the operating hand F toward the shift switches. The approach sensing unit may be, for example, a camera.

The exemplary embodiment described above illustrates an example in which the shifting apparatus 20 is disposed at the instrument panel 14. However, the shifting apparatus may be disposed at a center console, the steering wheel, or an alternative component in the vehicle cabin.

The disclosures of Japanese Patent Application No. 2022-112619 filed Jul. 13, 2022 are incorporated into the present specification by reference in their entirety.

All references, patent applications and technical specifications cited in the present specification are incorporated by reference into the present specification to the same extent as if the individual references, patent applications and technical specifications were specifically and individually recited as being incorporated by reference.

1. A shifting apparatus, comprising:
a shift switch that provides an operation instruction in accordance with contact of an operating hand;
an approach sensing unit that senses an approach of the operating hand toward the shift switch; and
a notification unit that, based on sensing information from the approach sensing unit, makes a notification that the operating hand has approached the shift switch.

2. The shifting apparatus according to claim 1, wherein:
at least two of the shift switch are provided in a row, and
the notification unit makes a notification for a shift switch among the at least two shift switches that the operating hand has approached.

3. The shifting apparatus according to claim 2, wherein the at least two shift switches are disposed in a row at a flat surface.

4. The shifting apparatus according to claim 1 wherein, based on the sensing information from the approach sensing unit, the notification unit makes notifications in stages that the operating hand is approaching the shift switch.

5. The shifting apparatus according to claim 1, wherein the notification unit is a light output unit that outputs light.

6. The shifting apparatus according to claim 1, wherein the notification unit is a sound output unit that outputs sound.
